(19) United States
(12) Patent Application Publication
(10) Pub. No.: US 2004/0093315 A1
(43) Pub. Date: May 13, 2004

(54) Neural network training

(76) Inventor: John Carney, Dublin (IE)

Correspondence Address: JACOBSON HOLMAN PLLC, 400 SEVENTH STREET N.W., SUITE 600, WASHINGTON, DC, 20004, US

(21) Appl. No.: 10/629,821

(22) Filed: Jul. 30, 2003

Related U.S. Application Data
(63) Continuation of application No. PCT/IE02/00013, filed on Jan. 31, 2002.

(30) Foreign Application Priority Data
Jan. 31, 2001 (IE) 2001/0075

(51) Int. Cl. G06G 7/62

(52) U.S. Cl. 706/15; 703/13

(57) ABSTRACT

A prediction model is generated by training an ensemble of multiple neural networks, and estimating the performance error of the ensemble. In a subsequent stage a subsequent ensemble is trained using an adapted training set so that the preceding bias component of performance error is modelled and compensated for in the the new ensemble. In each successive stage the error is compared with that of all of the preceding ensembles combined. No further stages take place when there is no improvement in error. Within each stage, the optimum number of iterative weight updates is determined, so that the variance component of performance error is minimised.

### FIELD OF THE INVENTION

The invention relates to a method and system to generate a prediction model comprising multiple neural networks.

### PRIOR ART DISCUSSION

Prediction of fuiture events is very important in many business and scientific fields. In some fields, such as insurance or finance, the ability to predict future conditions and scenarios accurately is critical to the success of the business. These predictions may relate to weather patterns for catastrophe risk management or stock price prediction for portfolio management. In other, more conventional business environments, prediction is increasingly playing a more important role. For example, many organisations today use customer relationship management methods that attempt to drive business decisions using predictions of customer behaviour.

Increasingly a more systematic, quantitative approach is being adopted by business to solve such prediction problems. This is because such business environment prediction problems are typically very difficult — the data is “real-world” data and may be corrupted or inconsistent. Also, the domain of interest will usually be characterised by a large number of variables, which are related in complex ways. One of the best quantitative prediction methods suggested in the art to date to solve such problems is the artificial neural network method.

Artificial neural networks are computer simulations loosely based on biological neural networks. They are usually implemented in software but can also be implemented in hardware. They consist of a set of neurons (mathematical processing units) interconnected by a set of weights. They are typically used to model the underlying characteristics of an input data set that represents a domain of interest, with a view to generating predictions when presented with scenarios that underlie the domain of interest.

Artificial neural networks have been applied in the art with moderate success for a variety of prediction problems. However, for very difficult prediction problems characterised by data where the signal to noise ratio is low and the number of related input variables is large, neural networks have only enjoyed limited success. This is because, when trained with such data, neural networks in basic form can be unstable i.e. small changes in parameter or data input can cause large changes in performance. This instability is often described as “over-fitting” — the network essentially fits (models) the noise in its trainmg data and cannot therefore generalise (predict) when presented with new unseen data.

A recent approach to overcome this problem involves the use of ensembles of neural networks rather than individual neural networks. Although each individual neural network in such an ensemble may be unstable, the combined ensemble of networks can consistently produce smoother, more stable predictions. However, such neural network ensembles can be difficult to train to provide an effective prediction model.

The invention is therefore directed towards providing a method for generating an improved prediction model.

### SUMMARY OF THE INVENTION

According to the invention, there is provided a method of generating a neural network prediction model, the method comprising the steps of:

a first stage:

(a) training an ensemble of neural networks, and

(b) estimating a performance error value for the ensemble;

in a subsequent stage:

(c) training a subsequent ensemble of neural networks using the performance error value for the preceding ensemble,

(d) estimating a performance. error value for a combination of the current ensemble and each preceding ensemble, and

(e) determining if the current performance error value is an improvement over the preceding value; and

(f) successively repeating steps (c) to (e) for additional subsequent stages until the current performance error value is not an improvement over the preceding error value; and

(g) combining all of the ensembles at their outputs to provide the prediction models.

In one embodiment, the step (a) is performed with bootstrap resampled training sets derived trom training sets provided by a user, the bootstrap resampled training sets comprising training vectors and associated prediction targets.

In another embodiment, the steps (a) and (c) each comprises a sub-step of automatically determining an optimum number of iterative weight updates (epochs) for the neural networks of the current ensemble.

In a further embodiment, thel optimum number of iterative weight updates is determined by use of out-of-sample bootstrap training vectors to simulate unseen test data.

In one embodiment, the sub-step of automatically determining an optimum number of iterative weight updates comprises:

computing generalisation error estimates for each training vector;

aggregating the generalisation error estimates for every update; and

determining the update having the smallest error for each network in the ensemble.

In one embodiment, a single optimum number of updates for all networks in the ensemble is determined.

In another embodiment, the step (c) trains the neural network to model the preceding error so that the current ensemble compensates the preceding error to minimise bias.

In a further embodiment, the method comprises. the further step of adapting the target component of each training vector to the bias of the current ensemble, and delivering the adapted training set for training a subsequent ensemble.

In one embodiment, the step of adapting the training set is performed after step (e) and before the next iteration of steps (c) to (e).

In another embodiment, steps (c) to (e) are not repeated above a pre-set limit number (S) of times.

In a further embodiment, the step (c) is performed with a pre-set upper bound (E) on the number of iterative weight updates.

In one embodiment, the method is performed with a pre-set upper bound on the number of networks in the ensembles.

According to another aspect, the invention provides a development system comprising means for generating a prediction model in a method as defined above.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a representation of a simple neural network;

FIG. 2 is a diagram illustrating a neural network node in more detail;

FIG. 3 is a plot of response of a neural network node;

FIG. 4 is a diagram illustrating an ensemble of neural networks;

FIG. 5 is a diagram illustrating generation of bootstrap training sets; and

FIGS. 6 to 10 are flow diagrams illustrating steps for generating a prediction model.

### DESCRIPTION OF THE EMBODIMENTS

The invention is directed towards generating a prediction model having a number of ensembles, each having a number of neural networks.

Neural Network

Neural networks essentially consist of three elements — a set of nodes (processing units), a specific architecture or topology of weighted interconnections between the nodes, and a training method which is used to set the weights on the interconnects given a particular training set (input data set).

Most neural networks that have been applied to solve practical real-world problems are multi-layered, feed-forward neural networks. They are “multi-layered” in that they consist of multiple layers of nodes. The first layer is called the input layer and it receives the data which is to be processed by the network. The next layer is called the hidden layer and it consists of the nodes which do most of the processing or modelling. There can be multiple hidden layers. The final layer is called the output layer and it produces the output, in a prediction model, a prediction. There can also be multiple outputs.

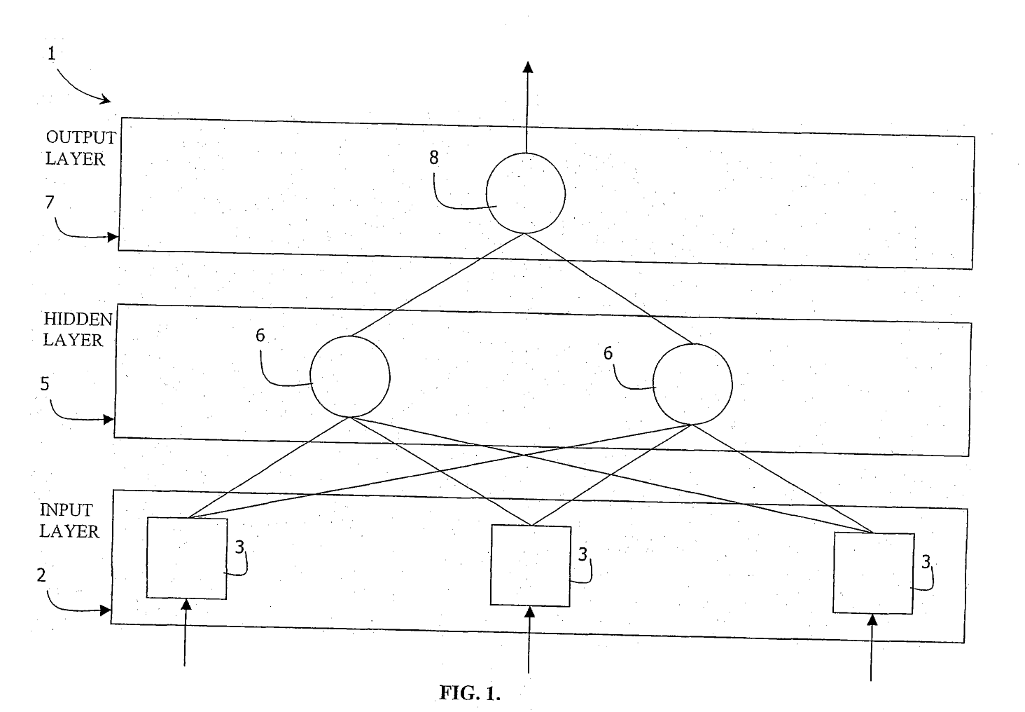

FIG. 1 is a representative example of such a multi-layered feed-forward neural network. The network 1 comprises an input layer 2 with input nodes 3, a hidden layer 5 having hidden nodes 6, and an output layer 7 having an output node 8. The network 1 is merely illustrative of one embodiment of a multi-layered feed-forward neural network. Despite the term “input layer” this layer does not actually contain processing nodes, the nodes 3 are merely a set of storage locations for the (one or more) inputs. There can be any number of hidden layers, imcluding zero hidden layers. The outputs of the nodes 8 in the output layer are the predictions generated by the neural network 1 given a particular set of inputs.

The inputs and the nodes in each layer are interconnected by a set of weights. These weights determine how much relative effect an input value has on the output of the node in question. If all nodes in a neural network have inputs that originate from nodes in the immediate previous layer the. network is said to be a feed-forward neural network. If a neural network has nodes that originate from nodes in a subsequent layer the network is said to be a recurrent or feedback neural network.

In the invention a prediction model is generated comprising a number of neural networks having die general structure of that shown in FIG. 1. However, in practice the actual networks are much larger and more complex and may comprise a number of sub-layers of nodes in the hidden layer 5.

The model may comprise of multi-layer feed-forward or recurrent neural networks. There is no limitation on the number of hidden layers, inputs or outputs in each neural network, or on the form of. the mathematical activation function used in die nodes.

Nodes

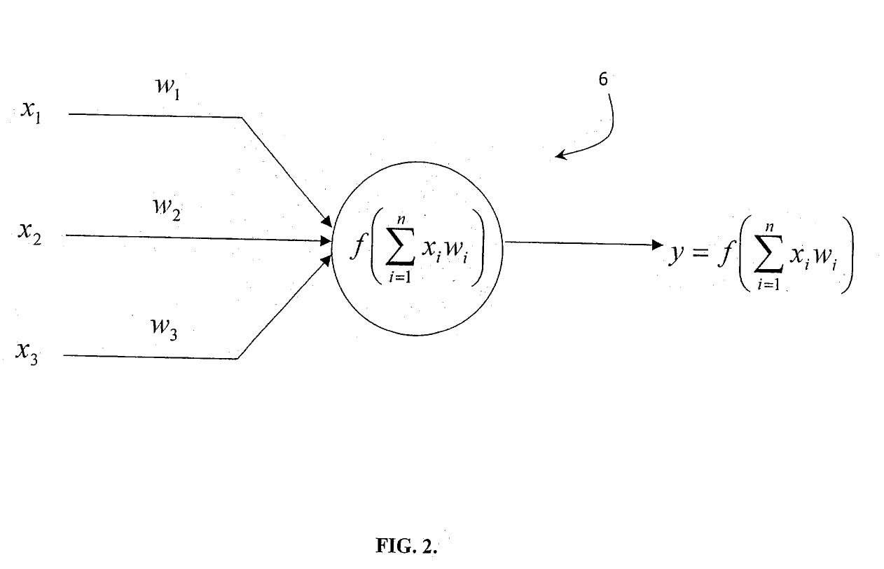

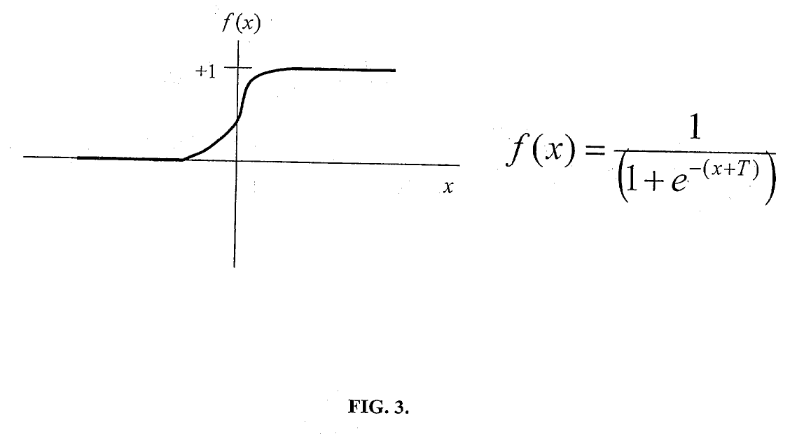

The nodes in the neural networks implement some mathematical activation function that is a nonlinear function of the weighted sum of the node inputs. In most neural networks all of these functions are the same for each node in the network, but they can differ. A typical node is detailed in FIG. 2. The activation function that such a node uses can take many forms. The most widely used: activation function for multi-layered networks is the “sigmoid”0 function, which is illustrated in FIG. 3. The activation function is used to determine the activity level generated in a node as a result of a particular input signal. The present invention is not limited to use of sigtoid activation nodes.

Inputs

The input data received at the input layer may be historical data stored in a computer database. The nature of this input data depends on the problem the user of the wishes to solve. For example, if the user wishes to train a neural network that predicts movements in a particular stock price, then he may wish to input historical data that represents how this stock behaved in the past. This may be represented by a number of vatiables or factors such as the daily price to earnings ratio of a company, the daily volume of the company's stock traded in thie markets and so on. Typically, the selection of which factors to input to a neural network is a decision made by the user.

The present invention is, not limited in terms of the number of inputs chosen by the user or the domain from which they are extracted. The only limitation is that they are represented in numeric form.

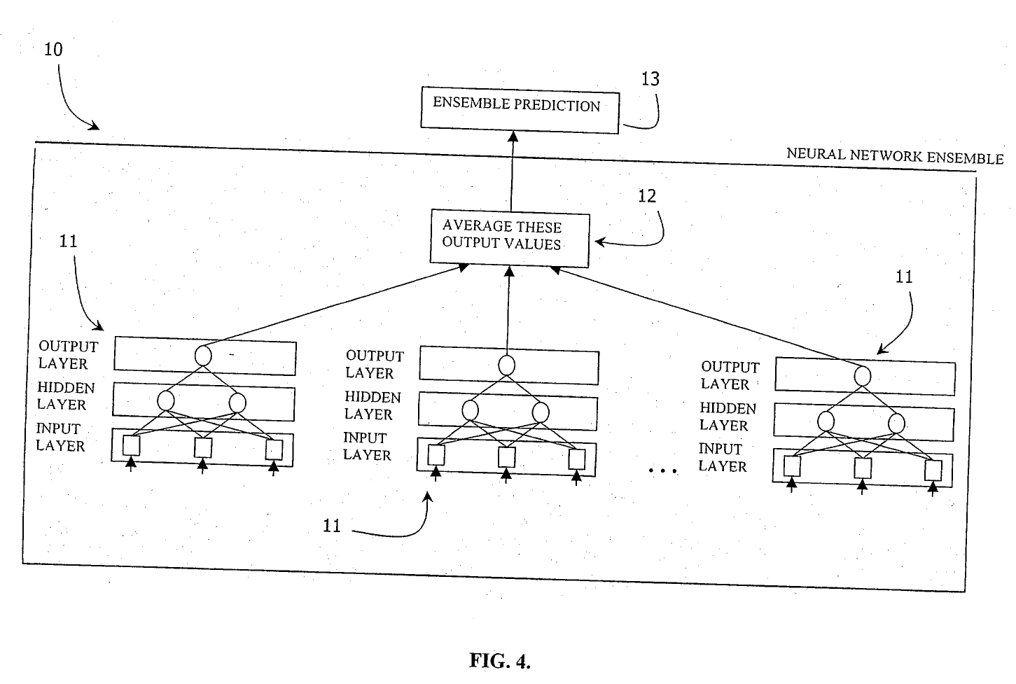

Referring to FIG. 4 part of a prediction model generated by a method of the invention is shown in simplified form. The part is an ensemble 10 having three networks 11, and a method 12 for combining the outputs of the networks 11. A complete prediction model comprises at least two neural networks. The model is built in stages, with an ensemble being developed in each stage.

Training a Single Neural Network

The weights that interconnect the nodes in a neural network are set during training. This training process is usually iterative — weights are initialised to small random values and then updated in an iterative fashion until the predictions generated by the neural network reach a user-specified level of accuracy. Accuracy is determined by comparing the output with a target output included with an input. vector. In this specification each weight update iteration is called an “epoch”.

The most popular training process used for multi-layered feed-forward neural networks is the back-propagation method. This works by feeding back an error through each layer of the network, from output to input layer, altering the weights so that the error is reduced. This error is some measure of the difference between the predictions generated by the network and the actual outputs.

The present invention is not limited to any particular multi-layered neural network training method. The only lirnitation is that the weights are updated in an iterative fashion.

Neural Network Ensemble

As shown in FIG. 4, the individual networks in an ensemble are combined via their outputs. Typical methods used to combine individual neural networks include taking a simple average of the output of each network or a weighted average of each neural network.

Clearly, it only makes sense to combine neural networks to form an ensemble if there is diversity amongst individual networks in the ensemble — if they are all identical nothing will be gained by using an ensemble. Diversity can be generated using a variety of methods. The most popular method is to randomly resample (with replacement) the input data-set to produce multiple data-sets. This process, which is described in detail below, is called “bootstrap re-sampling”.

The invention is not limited in terms of the number of networks in the ensemble, the architecture of each network in the ensemble, the type of nodes used in each network in the ensemble, or the training method used for each network in the ensemble (as long as it uses some iterative update to set the weights).

It is preferred that diversity in the ensemble is generated using bootstrap re-sampling and the individual networks are combined using a simple average of their outputs.

Bias and Variance in Neural Network Ensembles

Before describing the invention in detail, a discussion on the nature of generalisation (i.e. prediction) error in neural network modelling is of benefit. The generalisation error (i.e. the difference between predicted and actual values) in any prediction model can be decomposed into three components — noise-variance, bias and variance. The contribution of each error component to overall prediction error can vary significantly depending on the neural network architecture, the training method, the size of ensemble, and the input data used.

The noise-variance is the error due to-the unpredictable or random component of an input data set. It is high for most real-world prediction tasks because the signal-to-noise ratio is usually very low. The noise variance is a function of the fundamental characteristics of the data and so cannot be varied by the choice of modeling method or by the model building process.

The bias is high if a model is poorly specified i.e. it under-fits its data so that it does not effectively capture the details of the function that drives the input data.

The variance is high if a model is over specified i.e. it over-fits or “memorises” its data so that it can't generalise to new, unseen data.

Although the noise-variance component of generalisation error cannot be reduced during die model building process, the bias and variance components can. However, there is a trade-off or a dilemma — if bias is reduced, variance is increased and vice-versa. The present invention overcomes this dilemma. The training method trains neural network ensembles so that the bias and variance components of their generalisation error are reduced siunultaneously during the training process.

Put simply, a prediction model is generated in a series of steps as follows. A prediction model is generated by training an ensemble of multiple neural networks, and estimating the performance error of the ensemble. In a subsequent stage a subsequent ensemble is trained using an adapted training set so that the preceding bias component of performance error is modelled and compensated for in the new ensemble. In each successive stage thie error is compared with that of all of the preceding ensembles combined. No further stages take place when there is no improvement in error. Within each stage, the optimum number of iterative weight updates is deternined, so that the variance component of performance error is minimised.

The following describes the method in more detail.

(a) In a first stage, an initial ensemble of neural networks is generated. These neural networks have a standard configuration, typically with one hidden layer, one output node, one to ten hidden nodes and a sigmoid transfer function for each node. Typically, two to one hundred of these neural networks will be used for the ensemble.

(b) Still in the first stage, training data is inputted to the ensemble and the performance error (an estimated measure of the future or “on-line” prediction performance of the model) is determined.

(c) In a subsequent stage, the performance error of (b) is used to generate a subsequent ensemble. This step involves determnning an optimum number of epochs (“epot”), i.e. the number of training iterations (weight updates of the underlying learming method used e.g. back-propaaation) that correspond to the optimal set of weights for each neural network in the ensemble. This step minimises variance, which arises at the “micro” level within the ensemble of the stage. Also, the performance error of the first stage is modelled in the. new ensemble. Thus, it compensates for the error in the first ensemble. This aspect of the method minimises bias, which arises at the “macro” level of multiple ensembles.

(d) Still in the subsequent stage of step (c) the performance error of the combination of the previous and current ensembles is estimated.

(e) Steps (c) and (d) are repeated for each of a succession of stages, each involving generation of a fresh ensemble. The training ends when the error estimated in step (a) does not improve on the previously estimated errors.

(f) Finally, all the ensembles are combined (summed) at their outputs to provide the required prediction model.

Thus, within individual stages variance is corrected by the determination of the optimum number of epochs, while bias is corrected because each ensemble model and compensates for the bias of all preceding ensembles. The following describes the method in more detail.

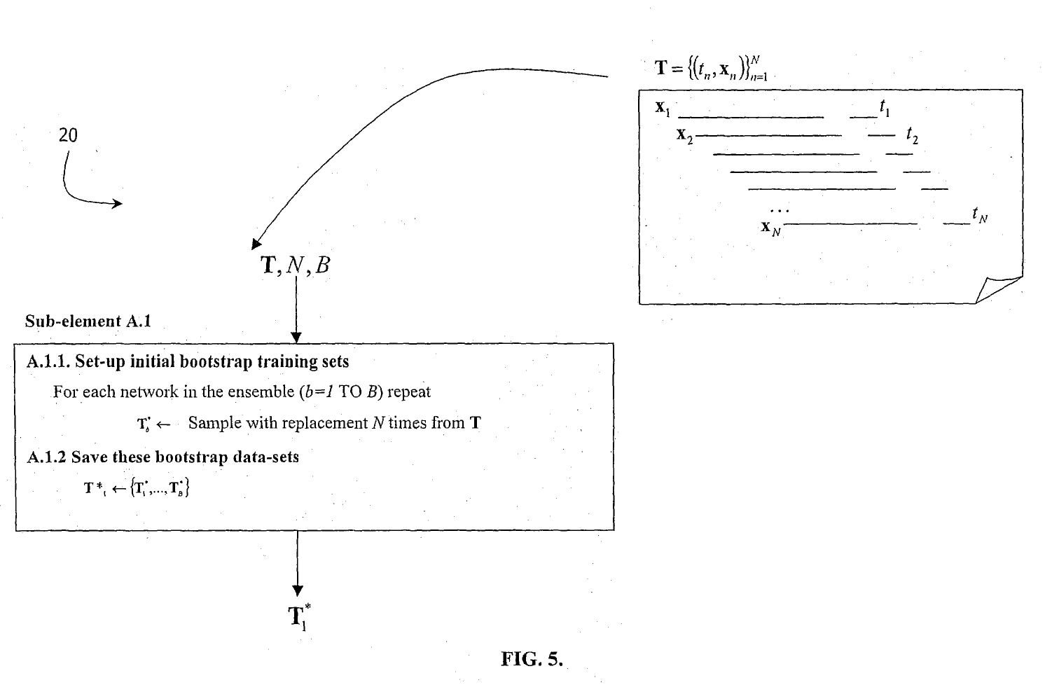

Referring to FIG. 5, to generate the initial neural networks, the user provides an original training set consisting of input vectors X₁, H₂. . . . . X_{N} and corresponding prediction targets t₁, t₂. . . . . t_{N}. In a step 20, a development system automatically uses the training set T and N (the number of input vectors) and B (the user-specified number of networks in the ensemble), to set up initial bootstrap training sets T₁*. In the following description, the following are the other parameters referred to.

“E”: The upper bound on the number of iterative weight updatesused to train each individual neural network, called “epochs”. The optimum number of epochs is between 1 and E.

“S”: The upper bound on the number of stages, also being the maximum number of ensembles that will be built. The optimum number of stages is in the range of 1 to S.

“W^{T}ₒₚₜ”: Optimal set of weights for an individual stage S.

“W*”: An optimal set of weights defining all ensembles of the end-product prediction model.

“A”: Performance (generalisation or prediction) error.

“Aₑ”: Performance error for particular ensemble.

“eₒₚₜ”: The optimal number of epochs for a stage.

“M”: The ensemble outputs for each training vector for a current stage.

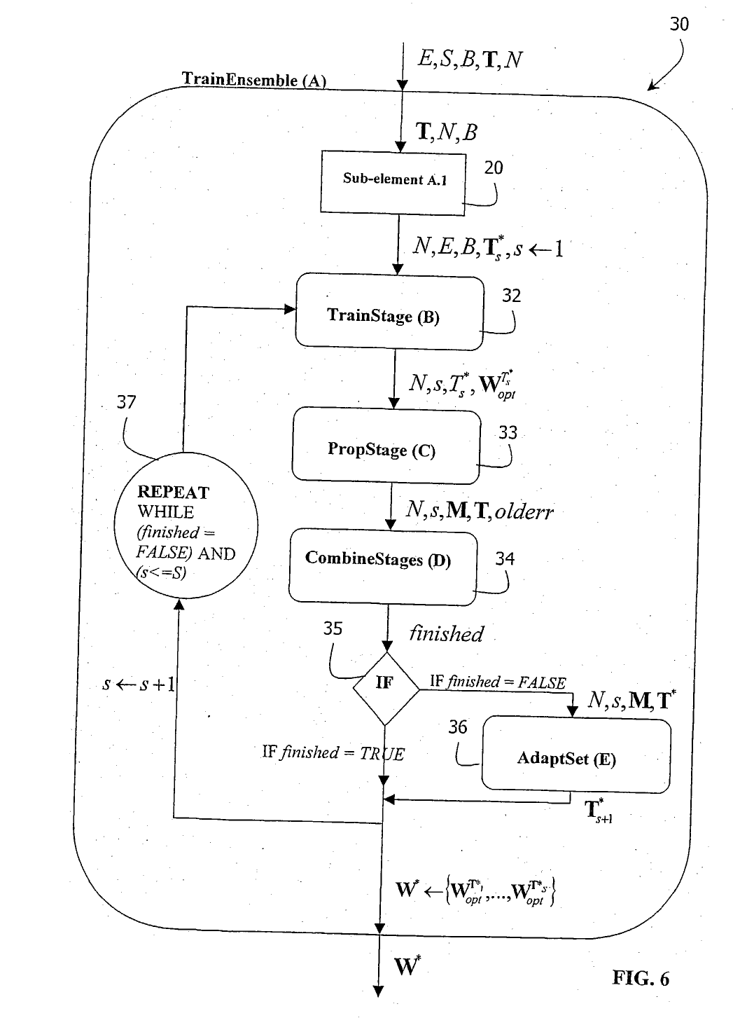

Referring to FIG. 6, the fill method is indicated generally by the numeral 30. The user only sees the inputs E, S, B, T, and N and the output W*, the beginning and end of the flow diagram.

In step 31 the bootstrap training sets T_{S}* are set up, as described above with reference to FIG. 5. The parameters N, E, B, T_{S}* are used for a step 32, namely training of an ensemble. This provides the parameter W^{T}* used as an input to a PropStage step 33, which pushes the training vectors through the ensemble to compensate ensemble outputs for each training example for the stage S.

In step 34 the existing ensembles are combined and it is determined if the error is being reduced from one stage to the next. If so, in step 36 the training set is adapted to provide T^{N}_{S+1} and steps 32 to 34 are repeated as indicated by the decision step 37. In the step 36 the performance error is used to adapt the bootstrap training set so that the next ensemble models. the error of all previous ensembles combined, so that bias is minimised.

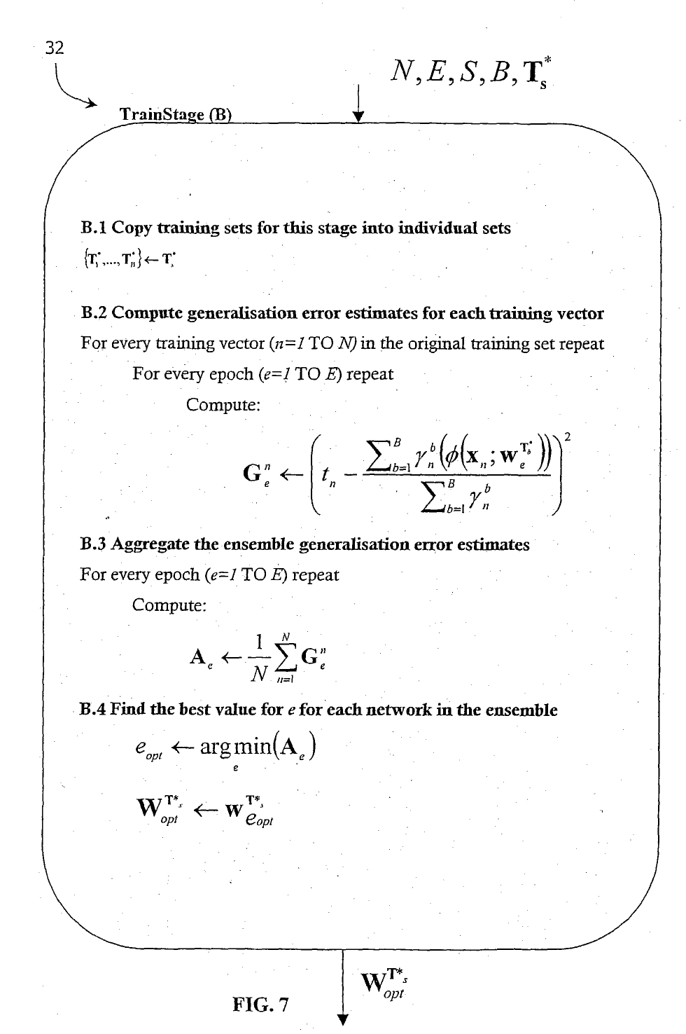

Referring to FIG. 7 the step 32 of training an ensemble is illustrated in detail. This step requires a number of inputs including N, E, S, B. which are described above. It also requires T*. This is the set of bootstrap re-sampled training sets that correspond to the current stage i.e. stage s. This element then outputs an optimal set of weights, W for this specific stage.

To find the optimal. set of weights, this step calculates ensemble generalisation error estimates at each epoch i.e. for each training iteration or weight update of the individual networks. It does this using “out-of-bootstrap” training vectors, which are conveniently produced as part of the sampling procedure used in bootstrap re-sampling. As described above, bootstrap re-sampling samples training vectors with replacement from the original training set. The probability that a training vector will not become part of a bootstrap re-sampled set is approximately (1-1/ N)^{N}≈0.368, where N is the number of training vectors in the original training set. This means that approximately 37% of the original training vectors will not be used for training i.e. they will be out-of-sample and can be used to simulate unseen, test data.

In more detail, the element labelled B1 copies the training vectors into individual bootstrap training sets so that they can be used for training. B2 computes ensemble generalisation error estimates for each training vector. Note that τ^{h}ₙ is a variable that indicates whether training vector η n is out-of-sample for bootstrap training set Tₕ or not; τ^{h}ₙ=1 if it is and τ^{h}ₙ≈0 if it is not. Also, note that ∅(xₙ;w^{T}_{c}) is used to represent the output (prediction) of an individual neural network, given input vector xₙ and weights trained (using backpropagation or some other iterative weight update method) for e epochs using training set Tₕ. B3 aggregates the ensemble generalisation error estimates for each training vector to produce an estimate for the average ensemble generalisation error. B.4 finds the optimal value for e i.e. the value for e that minimises the average ensemble generalisation error. The corresponding set of weights for each individual network in the ensemble are chosen as the optimal set. for the ensemble.

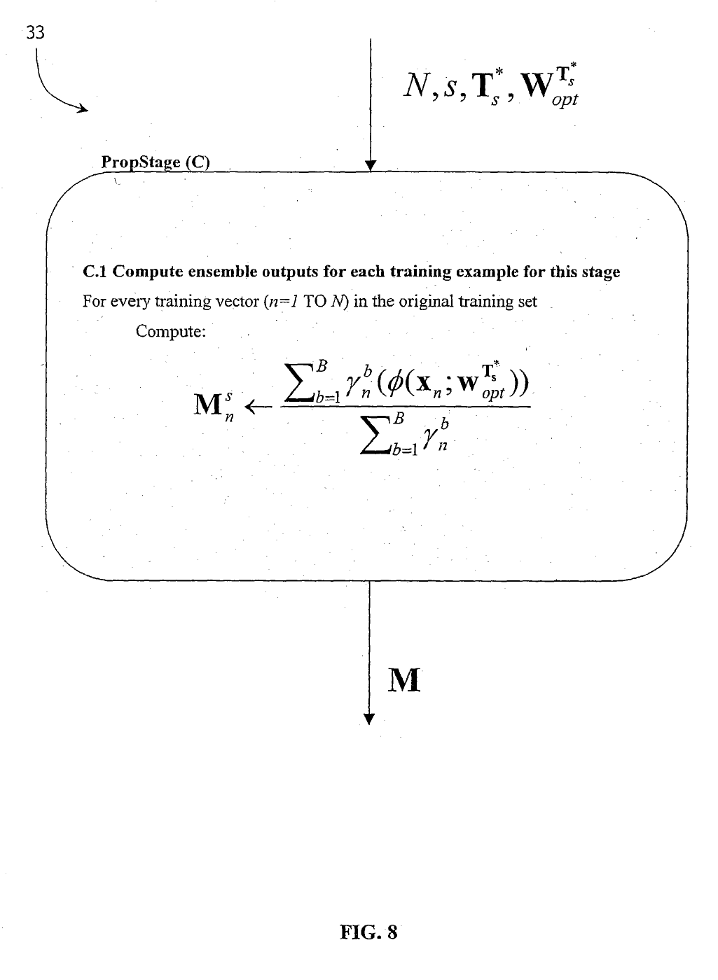

Referring to FIG. 8, the step 33 is illustrated in detail. This computes the outputs for each training vector for a single stage ie. propagates or feeds forward each training vector through an ensemble stage. These outputs will be used to adapt the training set. As input, this element requires N, s, T*, W^{T}ₒₚₜ. It outputs M, the ensemble outputs for each training vector for the current stage.

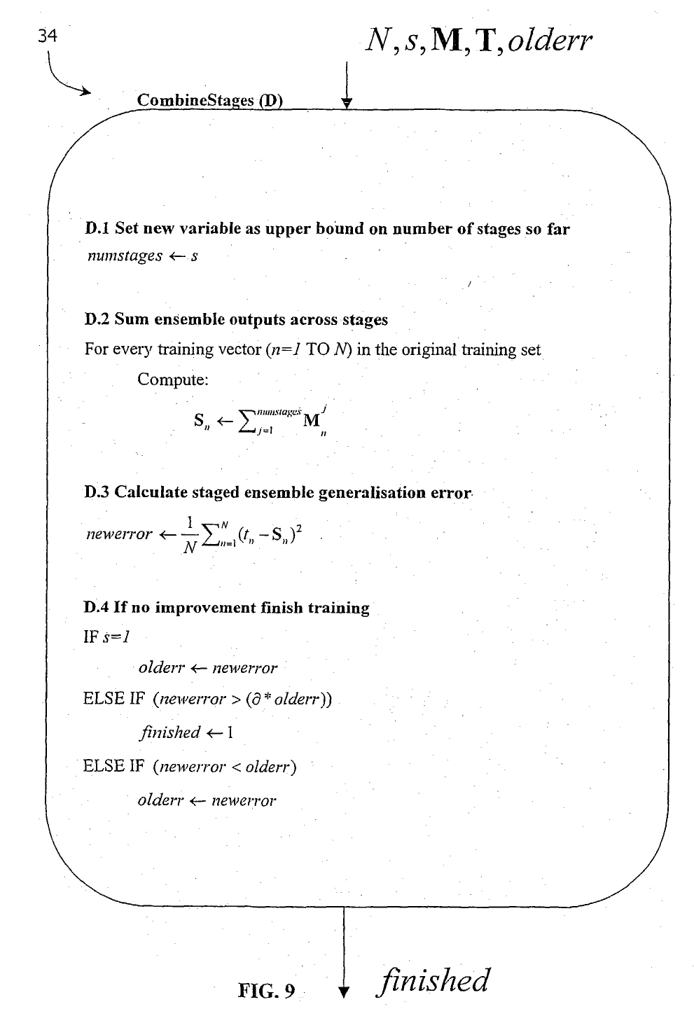

Referring to FIG. 9 the CombineStages step 34 is illustrated in detail. This combines the individual stages, by summing the ensemble outputs across the stages (among other things). As input this element requires N, s, M, T and olderr. The olders input is initialised inside this element the first time it is used. It outputs finished, a parameter that indicates whether or not any more stages need to be built. Thlis depends on a comparison of olden with the new error, newerr.

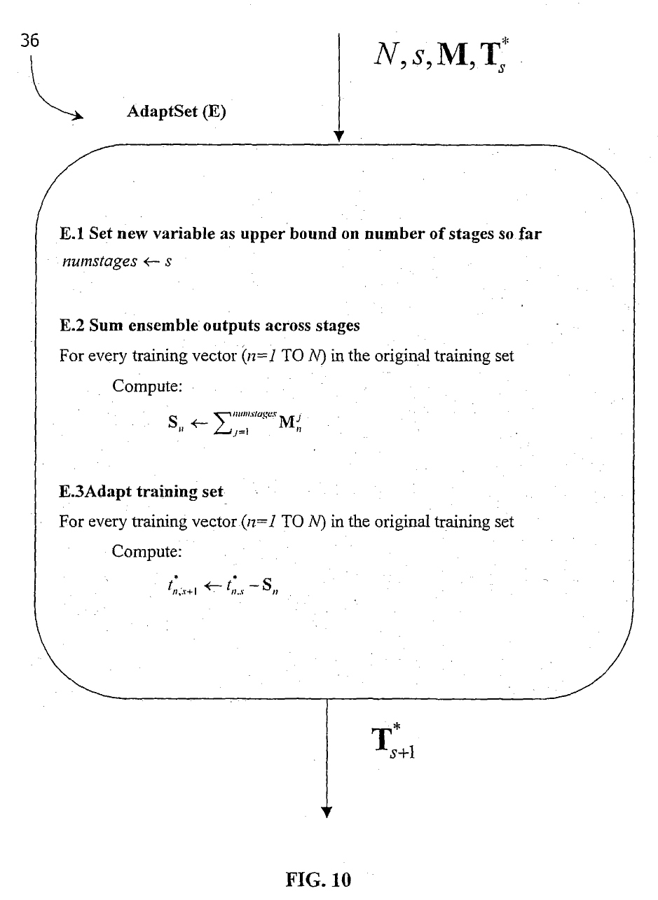

Referring to FIG. 10, the step 36 is illustrated in detail. This adapts the target component of each training vector in a training set used to build an ensemble. This adapted target is the bias of a stage. In essence, the method identifies bias in this way and then removes it by building another stage of the ensemble. As input: this step requires N,T s, M and T *.It outputs an adapted training set T*ₛ₊₁.

It has been found that the method 30 outputs a set oweghts (W^{.}) for a neural network ensemble that has a bias and variance close to zero. These weights, when combined with a corresponding network of nodes, can be used to generate predictions for any input vector drawn from the same probability distribution as the training set input vectors.

It will be appreciated that the invention provides the following improvements over the art:

It explicitly corrects for both bias andy variance ini neural networks.

It corrects for sources of bias that are difficult to detect and are not reflected in the average mean-squared generalisation error. For example, some time-series data such as financial data can have a dominant directdonal bias. This is problematic as it can cause neural network models to be built that perform well based on the average mean-squared error but poorly when predicting a directional change that is not well represented in the training data. The invention automatically corrects for this bias (along with usual sources of bias) despite it not being reflected in the average mean-squared generalisation error.

It uses an early-stopping based method to estimate average ensemble generalisation error. Good estimates of generalisation performance are critical to the method's success.

The a invention is not limited to the embodiments described but may be varied in construction and detail.

1. A method of generating a neural network prediction model, the method comprising the steps of:
in a first stage:
(a) training an ensemble of neural networks, and
(b) estimating a performance error value for the ensemble;
in a subsequent stage:
(c) training a subsequent ensemble of neural networks. using the performance error value for the preceding ensemble,
(d) estimating a performance error value for a combination of the current ensemble and each preceding ensemble, and
(e) determining if the current performance error value is an improvement over the preceding value; and
(f) successively repeating steps (c) to (e) for additional subsequent stages until the current performance error value is not an improvement over the preceding error value; and
(g) combining all of the ensembles at their outputs to provide the prediction model.

2. A method as claimed in claim 1, wherein the step (a) (20) is performed with bootstrap resampled training sets derived from training sets provided by a user, the bootstrap resarnpled training sets comprising training vectors and associated prediction targets.

3. A method as claimed in claim 1, wherein the steps (a) and (c) (32) each comprises a sub-step of automatically determining an optimum number of iterative weight updates (epochs) for the neural networks of the current ensemble.

4. A method as claimed in claim 3, wherein the optimum number of iterative weight updates is determined by use of out-of-sample bootstrap training vectors to simulate unseen test data.

5. A method as claimed in claim 3, wherein the sub-step of automatically determining an optimum number of iterative weight updates compnrses:
computing generalisation error estimates for each training vector;
aggregating the generalisation error estimates for every update; and
determining the update having the smallest error for each network in the ensemble.

6. A method as claimed in claim 3, wherein the optimum number of iterative weight updates is determined by use of out-of-sample bootstrap training vectors to simulate unseen test data; and wherein a single optimum number of updates for all networks in the ensemble is determined.

7. A method as claimed in claim 1, wherein the step (c) trains the neural network to model the preceding error so that the current ensemble compensates the preceding error to minimise bias.

8. A method as claimed in claim 7, wherein the method comprises the further step of adapting the target component of each training vector to the bias of the current ensemble, and delivering the adapted training set for training a subsequent ensemble.

9. A method as claimed in claim 7, wherein the method comprises the further step of adapting the target component of each training vector to the bias of the current ensemble, and delivering the adapted training set for training a: subsequent ensemble; and wherein the step of adapting the training set is performed. after step (e) and before the next iteration of steps (c) to (e).

10. A method as claimed in claim 1, wherein steps (c) to (e) are not repeated above a pre-set limit number (S) of times.

11. A method as claimed in claim 1, wherein the step (c) is performed with a pre-set upper bound (E) on the number of iterative weight updates.

12. A method as claimed in claim 1, wherein the method is performed with a pre-set upper bound on the number of networks in the ensembles.

13. A predication model whenever generated by a method as claimed in claim 1.

14. A development system comprising means for performing the method of claim 1.

15. A computer program product comprising software code for performing a method as claimed in claim 1 when executing on a digital computer.
